(19) United States
(12) Patent Application Publication
(10) Pub. No.: US 2025/0374086 A1
(43) Pub. Date: Dec. 4, 2025

(54) APPARATUS, METHOD, AND COMPUTER PROGRAM

(71) Applicant: Nokia Technologies Oy, Espoo (FI)

(72) Inventors: Muhammad Karam SHEHZAD, Massy (FR); Fahad SYED MUHAMMAD, Orsay (FR)

(21) Appl. No.: 19/207,487

(22) Filed: May 14, 2025

(30) Foreign Application Priority Data
May 28, 2024 (GB) 2407549.1

(51) Int. Cl. H04W 24/02; H04W 8/24

(52) U.S. Cl. CPC H04W 24/02; H04W 8/24

(57) ABSTRACT

The document relates to an apparatus comprising: means for receiving, from a base station, a request to receive user equipment capability information indicating whether the user equipment supports machine learning models for managing channel state information feedback; and means for transmitting, to the base station, user equipment capability information indicating the user equipment supports machine learning models for managing channel state information feedback.

### FIELD OF THE DOCUMENT

The present document relates to an apparatus, a method, and a computer program for managing channel state information feedback in a communication system.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 4G, 5G or 6G standards.

### SUMMARY

According to an aspect there is provided a user equipment comprising: means for receiving, from a base station, a channel state information reference signal CSI-RS(t0) on a primary component carrier and on at least one of secondary component carriers; and means for transmitting, to the base station, an uncompressed or a compressed common part

$$Q ( {\hat{H}}_{P S}^{UE} ( t 0 ) )$$

between channel state information for the primary component carrier

$${\hat{H}}_{P}^{UE} ( t 0 )$$

and channel state information for the at least one of secondary carrier

$${\hat{H}}_{S}^{U E} ( t 0 ) ,$$

wherein channel state information for the primary component carrier

$${\hat{H}}_{P}^{UE} ( t 0 )$$

is based on the channel state information reference signal CSI-RS (t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

The user equipment may comprise: means for transmitting, to the base station, an update Δₜ₁ between a prediction of a common part

$${\tilde{H}}_{PS}^{UE} ( t 1 )$$

and a common part

$${\hat{H}}_{PS}^{UE} ( t 1 )$$

between channel state information for a primary component carrier

$${\hat{H}}_{P}^{UE} ( t 1 )$$

and a channel state information for the primary component carrier

$${\hat{H}}_{S}^{UE} ( t 1 ) ,$$

wherein channel state information for the primary component carrier

$${\hat{H}}_{P}^{UE} ( t 1 )$$

is based on the channel state information reference signal CSI-RS(t1) on the primary component carrier, and channel state information for the at least one of secondary component carriers

$${\hat{H}}_{S}^{UE} ( t 1 )$$

is based on the channel state information reference signal CSI-RS(t1) on the at least one of secondary component carriers.

Channel state information for a primary component carrier

$${\hat{H}}_{P}^{UE} ( t 1 )$$

may comprise a first vector of elements.

The first vector of elements may comprise at least one of: a rank indicator element; a pre-coding matrix indicator element or a channel quality indicator element.

Channel state information for at least one of secondary component carriers

$${\hat{H}}_{S}^{UE} ( t 1 )$$

may comprise a second vector of elements.

The second vector of elements may comprise at least one of: a rank indicator element; a pre-coding matrix indicator element or a channel quality indicator element.

The common part

$${\hat{H}}_{PS}^{UE} ( t 1 )$$

between channel state information for a primary component carrier

$${\hat{H}}_{P}^{UE} ( t 1 )$$

and channel state information for at least one of secondary component carriers

$${\hat{H}}_{S}^{UE} ( t 1 )$$

may comprise a third vector of elements.

The third vector of elements may comprise at least one of: elements present in the first vector of elements and present in the second vector of elements; or elements present in the first vector of elements differing from elements present in the second vector of elements by less than a threshold.

The user equipment may comprise: means for providing the uncompressed or compressed common part

$$Q ( {\hat{H}}_{PS}^{UE} ( t 0 ) )$$

as an input to a first machine learning model to output the prediction of the common part

$${\tilde{H}}_{PS}^{UE} ( t 1 ) ;$$

and/or means for providing an uncompressed or compressed common part

$$Q ( {\hat{H}}_{PS}^{UE} ( t 1 ) )$$

to a first machine learning model to output a prediction of a common part

$${\tilde{H}}_{PS}^{UE} ( t 2 ) .$$

The update Δₜ₁ between the prediction of the common part

$${\tilde{H}}_{PS}^{UE} ( t 1 )$$

and the common part

$${\hat{H}}_{PS}^{UE} ( t 1 )$$

may comprise a difference between the prediction of the common part

$${\tilde{H}}_{PS}^{UE} ( t 1 )$$

and the common part

$${\hat{H}}_{PS}^{UE} ( t 1 ) .$$

The user equipment may comprise: means for providing an uncompressed or compressed prediction of the common part

$$Q ( {\tilde{H}}_{PS}^{UE} ( t 1 ) )$$

to a first machine learning model to obtain a prediction of a common part

$${\tilde{H}}_{PS}^{UE} ( t 2 ) .$$

The user equipment may comprise: means for obtaining, a common part

$${\hat{H}}_{PS}^{UE} ( t 2 )$$

between channel state information for the primary component carrier

$${\hat{H}}_{P}^{UE} ( t 2 )$$

and channel state information for the at least one of secondary component carriers

$${\hat{H}}_{S}^{UE} ( t 2 ) ;$$

means for obtaining, by the user equipment, an update Δₜ₂ between the prediction of the common part

$${\tilde{H}}_{PS}^{UE} ( t 2 )$$

and the common part

$${\hat{H}}_{PS}^{UE} ( t 2 ) ;$$

and transmitting, by the user equipment to the base station, the update Δₜ₂

Means for transmitting, to the base station, an update Δₜ₁ between a prediction of a common part

$${\tilde{H}}_{PS}^{UE} ( t 1 )$$

and a common part

$${\hat{H}}_{PS}^{UE} ( t 1 )$$

between channel state information for a primary component carrier

$${\hat{H}}_{P}^{UE} ( t 1 )$$

and channel state information for at least one of secondary component carriers

$${\hat{H}}_{S}^{UE} ( t 1 )$$

and/or the update Δₜ₂ between the prediction of a common part

$${\tilde{H}}_{PS}^{UE} ( t 2 )$$

and the common part

$${\hat{H}}_{PS}^{UE} ( t 2 )$$

between channel state information for a primary component carrier

$${\hat{H}}_{P}^{UE} ( t 2 )$$

and channel state information for at least one of secondary component carriers

$${\hat{H}}_{S}^{UE} ( t 2 )$$

may comprise: means for transmitting, to the base station, the update Δₜ₁ between the prediction of a common part

$${\tilde{H}}_{PS}^{UE} ( t 1 )$$

and the common part

$${\hat{H}}_{PS}^{UE} ( t 1 )$$

based on the update Δₜ₁ and a first threshold; and/or means for transmitting, to the base station, the update Δₜ₂ between the prediction of a common part

$${\tilde{H}}_{PS}^{UE} ( t 2 )$$

and the common part

$${\hat{H}}_{PS}^{UE} ( t 2 )$$

based on the update Δₜ₂ and second threshold.

The first threshold and the second threshold may be the same or different.

The user equipment may comprise: means for obtaining the first threshold and/or second threshold based on a received configuration or pre-configuration.

Means for transmitting, to the base station, the update Δₜ₁ between the prediction of a common part

$${\tilde{H}}_{PS}^{UE} ( t 1 )$$

and the common part

$${\hat{H}}_{PS}^{UE} ( t 1 )$$

based on the update Δₜ₁ and the first threshold may comprise: means for transmitting, to the base station, the update Δₜ₁, when the update Δₜ₁, when the update Δₜ₁ smaller than the first threshold.

Means for transmitting, to the base station, the update Δₜ₂ between the prediction of a common part

$${\tilde{H}}_{PS}^{UE} ( t 2 )$$

and the common part

$${\hat{H}}_{PS}^{UE} ( t 2 )$$

based on the update Δₜ₂ and the second threshold may comprise: means for transmitting, to the base station, the update Δₜ₂, when the update Δₜ₂ is greater than the second threshold; or means for not transmitting, to the base station, the update Δₜ₂, when the update Δₜ₂ is smaller than the second threshold.

The user equipment may comprise: means for obtaining a common part

$${\hat{H}}_{PS}^{UE} ( tn )$$

between channel state information for the primary component carrier

$${\hat{H}}_{P}^{UE} ( tn )$$

and channel state information for the secondary component carrier

$${\hat{H}}_{S}^{UE} ( tn ) ;$$

means for obtaining a common part

$${\hat{H}}_{PS}^{UE} ( tn + 1 )$$

between channel state information for the primary component

$${\hat{H}}_{P}^{UE} ( tn + 1 )$$

and channel state information for the secondary component carrier

$${\hat{H}}_{S}^{UE} ( tn + 1 ) ;$$

and means for using an uncompressed or compressed common part

$$Q ( {\hat{H}}_{PS}^{UE} ( tn ) )$$

and the common part

$${\hat{H}}_{PS}^{UE} ( tn + 1 )$$

for training a first machine learning so that the first machine learning model outputs a prediction of the common part

$${\tilde{H}}_{PS}^{UE} ( tn + 1 )$$

based on the uncompressed or compressed common part

$$Q ( {\hat{H}}_{PS}^{UE} ( tn ) ) .$$

The user equipment may comprise: means for transmitting, to the base station, the uncompressed or compressed common part

$$Q ( {\hat{H}}_{PS}^{UE} ( tn ) ) ,$$

channel state information for a primary component carrier

$${\hat{H}}_{P}^{UE} ( tn + 1 )$$

and channel state information for a secondary component carrier

$${\hat{H}}_{S}^{UE} ( tn + 1 )$$

for training a second machine learning model so the second machine learning model outputs a prediction of the primary component carrier

$${\tilde{H}}_{P}^{gNB} ( tn + 1 )$$

and a prediction of channel state information for the secondary component carrier

$${\tilde{H}}_{s}^{gNB} ( tn + 1 )$$

based on the compressed common part

$$Q ( {\hat{H}}_{PS}^{UE} ( tn ) ) .$$

The user equipment may comprise: means for receiving, from the base station, a request to receive user equipment capability information indicating whether the user equipment supports machine learning models for managing channel state information feedback.

The user equipment may comprise: means for transmitting, to the base station, user equipment capability information indicating the user equipment supports machine learning models for managing channel state information feedback.

The user equipment may comprise: means for transmitting, to the base station, at least one of characteristics of a first machine learning model or characteristics of a training data set.

The characteristics of the first machine learning model may comprise at least one of a number of layers of a neural network and/or a number of nodes per layer of a neural network; and/or the characteristics of the training data set may comprise a length of the training data set to train the first machine learning model.

According to an aspect there is provided a method comprising: receiving, from a base station, a channel state information reference signal CSI-RS(t0) on a primary component carrier and on at least one of secondary component carriers; and transmitting, to the base station, an uncompressed or a compressed common

$$Q ( {\hat{H}}_{PS}^{UE} ( t 0 ) )$$

between channel state information for the primary component carrier

$${\hat{H}}_{P}^{UE} ( t 0 )$$

and channel state information for the at lease one of secondary component carriers

$${\hat{H}}_{S}^{UE} ( t 0 ) ,$$

wherein channel state information for the primary component carriers

$${\hat{H}}_{P}^{UE} ( t 0 )$$

is based on the channel state information reference signal CSI-RS(t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

The method may comprise: transmitting, to the base station, an update Δₜ₁ between a prediction of a common part

$${\tilde{H}}_{PS}^{UE} ( t 1 )$$

and a common part

$${\hat{H}}_{PS}^{UE} ( t 1 )$$

between channel state information for a primary component carrier

$${\hat{H}}_{P}^{UE} ( t 1 )$$

and channel state information for at least one of secondary component carriers

$${\hat{H}}_{S}^{UE} ( t 1 ) ,$$

wherein channel state information for the primary component carrier

$${\hat{H}}_{P}^{UE} ( t 1 )$$

is based on the channel state information reference signal CSI-RS(t1) on the primary component carrier, and channel state information for the at least one of secondary component carriers

$${\hat{H}}_{S}^{UE} ( t 1 )$$

is based on the channel state information reference signal CSI-RS(t1) on the at least one of secondary component carriers.

Channel state information for a primary component carrier

$${\hat{H}}_{P}^{UE} ( t 1 )$$

may comprise a first vector of elements.

The first vector of elements may comprise at least one of: a rank indicator element; a pre-coding matrix indicator element or a channel quality indicator element.

Channel state information for at least one of secondary component carriers

$${\hat{H}}_{S}^{UE} ( t 1 )$$

may comprise a second vector of elements.

The second vector of elements may comprise at least one of: a rank indicator element; a pre-coding matrix indicator element or a channel quality indicator element.

The common part

$${\hat{H}}_{PS}^{UE} ( t 1 )$$

between channel state information for a primary component carrier

$${\hat{H}}_{P}^{UE} ( t 1 )$$

and channel state information for at least one of secondary component carriers

$${\hat{H}}_{S}^{UE} ( t 1 )$$

may comprise a third vector of elements.

The third vector of elements may comprise at least one of: elements present in the first vector of elements and present in the second vector of elements; or elements present in the first vector of elements differing from elements present in the second vector of elements by less than a threshold.

The method may comprise: providing the uncompressed or compressed common part

$$Q ( {\hat{H}}_{PS}^{UE} ( t 0 ) )$$

as an input to a first machine learning model to output the prediction of the common part

$${\tilde{H}}_{PS}^{UE} ( t 1 ) ;$$

and/or providing an uncompressed or compressed common part

$$Q ( {\hat{H}}_{PS}^{UE} ( t 1 ) )$$

to a first machine learning model to output a prediction of a common part

$${\tilde{H}}_{PS}^{UE} ( t 2 ) .$$

The update Δₜ₁ between the prediction of the common part

$${\tilde{H}}_{PS}^{UE} ( t 1 )$$

and the common part

$${\hat{H}}_{PS}^{UE} ( t 1 )$$

may comprise a difference between the prediction of the common part

$${\tilde{H}}_{PS}^{UE} ( t 1 )$$

and the common part

$${\hat{H}}_{PS}^{UE} ( t 1 ) .$$

The method may comprise: providing an uncompressed or compressed prediction of the common part

$$Q ( {\tilde{H}}_{PS}^{UE} ( t 1 ) )$$

to a first machine learning model to obtain a prediction of a common part.

$${\tilde{H}}_{PS}^{UE} ( t 2 ) .$$

The method may comprise: obtaining, a common part

$${\hat{H}}_{P S}^{U E} ( t 2 )$$

and channel state information for the at lease one of secondary component carriers

$${\hat{H}}_{P}^{U E} ( t 2 )$$

and channel state information for the at least one of secondary component carriers

$${\hat{H}}_{S}^{U E} ( t 2 ) ;$$

obtaining, by the user equipment, an update Δₜ₂ between the prediction of the common part

$${\tilde{H}}_{P S}^{U E} ( t 2 )$$

and the common part

$${\hat{H}}_{P S}^{U E} ( t 2 ) ;$$

and transmitting, by the user equipment to the base station, the update Δₜ₂

Transmitting, to the base station, an update Δₜ₁ between a prediction of a common part

$${\tilde{H}}_{P S}^{U E} ( t 1 )$$

and a common part

$${\hat{H}}_{P S}^{U E} ( t 1 )$$

between channel state information for a primary component carrier

$${\hat{H}}_{P}^{U E} ( t 1 )$$

and channel state information for at least one of secondary component carriers

$${\hat{H}}_{S}^{U E} ( t 1 )$$

and/or the update Δₜ₂ between the prediction of a common part

$${\tilde{H}}_{P S}^{U E} ( t 2 )$$

and the common part

$${\hat{H}}_{P S}^{U E} ( t 2 )$$

between channel state information for a primary component carrier

$${\hat{H}}_{P}^{U E} ( t 2 )$$

and channel state information for at least one of secondary component carriers

$${\hat{H}}_{S}^{U E} ( t 2 )$$

may comprise: transmitting, to the base station, the update Δₜ₁ between the prediction of a common part

$${\tilde{H}}_{P S}^{U E} ( t 1 )$$

and the common part

$${\hat{H}}_{P S}^{U E} ( t 1 )$$

based on the update Δₜ₁ and a first threshold; and/or transmitting, to the base station, the update Δₜ₂ between the prediction of a common part

$${\tilde{H}}_{PS}^{UE} ( t 2 )$$

and the common part

$${\hat{H}}_{PS}^{UE} ( t 2 )$$

based on the update Δₜ₂ and a second threshold.

The first threshold and the second threshold may be the same or different.

The method may comprise: means for obtaining the first threshold and/or second threshold based on a received configuration or pre-configuration.

Transmitting, to the base station, the update Δₜ₁ between the prediction of a common part

$${\tilde{H}}_{PS}^{UE} ( t 1 )$$

and the common part

$${\hat{H}}_{PS}^{UE} ( t 1 )$$

based on the update Δₜ₁ and the first threshold may comprise: transmitting, to the base station, the update Δₜ₁ is greater than the first threshold; or means for not transmitting, to the base station, the update Δₜ₁ , when the update Δₜ₁ is smaller than the first threshold.

Transmitting, to the base station, the update Δₜ₂ between the prediction of a common part

$${\tilde{H}}_{PS}^{UE} ( t 2 )$$

and the common part

$${\hat{H}}_{PS}^{UE} ( t 2 )$$

based on the update Δₜ₂ and the second threshold may comprise: transmitting, to the base station, the update Δₜ₂, when the update Δₜ₂ is greater than the second threshold; or means for not transmitting, to the base station, the update Δₜ₂, when the update Δₜ₂ is smaller than the second threshold.

The method may comprise: obtaining a common part

$${\hat{H}}_{PS}^{UE} ( tn )$$

between channel state information for the primary component carrier

$${\hat{H}}_{P}^{UE} ( tn )$$

and channel state information for the secondary component carrier

$${\hat{H}}_{P}^{UE} ( tn ) ;$$

obtaining a common part

$${\hat{H}}_{PS}^{UE} ( tn + 1 )$$

channel state information for the primary component carrier

$${\hat{H}}_{P}^{UE} ( tn + 1 )$$

and channel state information for the secondary component carrier

$${\hat{H}}_{S}^{UE} ( tn + 1 ) ;$$

and using an uncompressed or compressed common part

$$Q ( {\hat{H}}_{PS}^{UE} ( tn ) )$$

and the common part

$${\hat{H}}_{PS}^{UE} ( tn + 1 )$$

for training a first machine learning so that the first machine learning model outputs a prediction of the common part

$${\tilde{H}}_{P S}^{UE} ( tn + 1 )$$

based on the uncompressed or compressed common part

$$Q ( {\hat{H}}_{PS}^{UE} ( tn ) ) .$$

The method may comprise: transmitting, to the base station, the uncompressed or compressed common part

$$Q ( {\hat{H}}_{P S}^{UE} ( tn ) ) ,$$

channel state information for a primary component carrier

$${\hat{H}}_{P}^{UE} ( tn + 1 )$$

and channel state information for a secondary component carrier

$${\hat{H}}_{S}^{UE} ( tn + 1 )$$

for training a second machine learning model so that the second machine learning model outputs a prediction of the primary component carrier

$${\tilde{H}}_{P}^{g N B} ( tn + 1 )$$

and a prediction of channel state information for the secondary component carrier

$${\tilde{H}}_{s}^{g N B} ( tn + 1 )$$

based on the compressed common part

$$Q ( {\hat{H}}_{P S}^{UE} ( tn ) ) .$$

The method may comprise: receiving, from the base station, a request to receive user equipment capability information indicating whether the user equipment supports machine learning models for managing channel state information feedback.

The method may comprise: transmitting, to the base station, user equipment capability information indicating the user equipment supports machine learning models for managing channel state information feedback.

The method may comprise: transmitting, to the base station, at least one of characteristics of a first machine learning model or characteristics of a training data set.

The characteristics of the first machine learning model may comprise at least one of a number of layers of a neural network and/or a number of nodes per layer of a neural network; and/or the characteristics of the training data set may comprise a length of the training data set to train the first machine learning model.

According to an aspect there is provided a user equipment comprising at least one processor and at least one memory storing instructions that, when executed by the at least one processor, cause the apparatus at least to perform: receiving, from a base station, a channel state information reference signal CSI-RS(t0) on a primary component carrier and on at least one of secondary component carriers; and transmitting, to the base station, an uncompressed or a compressed common part

$$Q ( {\hat{H}}_{P S}^{U E} ( t 0 ) )$$

between channel state information for the primary component

$${\hat{H}}_{P}^{U E} ( t 0 )$$

and channel state information for the at least one secondary component carriers

$${\hat{H}}_{S}^{U E} ( t 0 ) ,$$

wherein channel state information for the primary component carrier

$${\hat{H}}_{P}^{U E} ( t 0 )$$

is based on the channel state information reference signal CSI-RS(t0) on the primary component carrier, and channel state information for the at least one of of secondary component carriers

$${\hat{H}}_{S}^{U E} ( t 0 )$$

is based on the channel state information reference CSI-RS(t0) on the at least one of secondary component carriers.

According to an aspect there is provided a user equipment comprising circuitry configured to perform: receiving, from a base station, a channel state information reference signal CSI-RS(t0) on a primary component carrier and on at least one of secondary component carriers; and transmitting, to the base station, an uncompressed or a compressed common part

$$Q ( {\hat{H}}_{PS}^{U E} ( t 0 ) )$$

between channel state information for the primary component carrier

$${\hat{H}}_{P}^{U E} ( t 0 )$$

and channel state information for the at least one of secondary component carriers

$${\hat{H}}_{S}^{U E} ( t 0 ) ,$$

wherein channel state information for the primary component carrier

$${\hat{H}}_{P}^{UE} ( t 0 )$$

is based on the channel state information reference signal CSI-RS(t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

According to an aspect there is provided a computer program comprising computer executable code which when run on at least one processor is configured to perform: receiving, from a base station, a channel state information reference signal CSI-RS(t0) on a primary component carrier and on at least one of secondary component carriers; and transmitting, to the base station, an uncompressed or a compressed common part

$$Q ( {\hat{H}}_{PS}^{UE} ( t 0 ) )$$

between channel state information for the primary component carrier

$${\hat{H}}_{P}^{UE} ( t 0 )$$

and channel state information for the at least one of secondary component carriers

$${\hat{H}}_{S}^{UE} ( t 0 ) ,$$

wherein channel state information for the primary component carrier

$${\hat{H}}_{P}^{UE} ( t 0 )$$

is based on the channel state information reference signal CSI-RS(t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

According to an aspect there is provided a base station comprising: means for transmitting, to a user equipment, a channel state information reference signal CSI-RS(t0) on a primary component carrier and on at least one of secondary component carriers; and means for receiving, from the user equipment, an uncompressed or a compressed common part

$$Q ( {\hat{H}}_{PS}^{UE} ( t 0 ) )$$

between channel information for the primary component carrier

$${\hat{H}}_{P}^{UE} ( t 0 )$$

and channel state information for the at least one of secondary component carriers

$${\hat{H}}_{S}^{UE} ( t 0 ) ,$$

wherein channel state information for the primary component carrier

$${\hat{H}}_{P}^{UE} ( t 0 )$$

is based on the channel state information reference signal CSI-RS(t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

The base station may comprise: means for providing, the uncompressed or compressed common part

$$Q ( {\hat{H}}_{PS}^{UE} ( t 0 ) )$$

as an input to a second machine learning model to output a prediction of channel state information for a primary component carrier

$${\tilde{H}}_{P}^{gNB} ( t 1 )$$

and a prediction of channel state information for a secondary component carrier

$${\tilde{H}}_{S}^{gNB} ( t 1 ) ;$$

and means for obtaining, a prediction of a common part

$${\tilde{H}}_{PS}^{gNB} ( t 1 )$$

between a prediction of channel state information for the primary component carrier

$${\tilde{H}}_{P}^{gNB} ( t 1 )$$

and a prediction of channel state information for the at least one of secondary component carriers

$${\tilde{H}}_{S}^{gNB} ( t 1 )$$

based on the prediction of channel state information for the primary component carrier

$${\tilde{H}}_{P}^{gNB} ( t 1 )$$

and the prediction of channel state information for the at least one of secondary component carriers

$${\tilde{H}}_{S}^{gNB} ( t 1 ) .$$

The base station may comprise: means for obtaining a prediction of channel state information for the primary component carrier

$${\tilde{H}}_{P}^{gNB} ( t 2 )$$

and a prediction or channel state information for the at least one of secondary component carriers

$${\tilde{H}}_{S}^{gNB} ( t 2 )$$

based on at least one of the prediction of the common part

$${\tilde{H}}_{PS}^{gNB} ( t 1 )$$

and an update Δₜ₁.

The base station may comprise: means for transmitting, to the user equipment, a first threshold and/or a second threshold.

The base station may comprise: means for receiving, from the user equipment, an update Δₜ₁ between a prediction of a common part

$${\tilde{H}}_{P S}^{U E} ( t 1 )$$

and a common part

$${\hat{H}}_{P S}^{U E} ( t 1 )$$

between channel state information for a primary component carrier

$${\hat{H}}_{P}^{U E} ( t 1 )$$

and channel state information for the at least one of secondary component carriers

$${\hat{H}}_{S}^{U E} ( t 1 )$$

wherein channel state information for the at least one of secondary component carriers

$${\hat{H}}_{P}^{U E} ( t 1 )$$

based on the channel state information reference signal CSI-RS(t1) on the primary component carrier, and channel state information for the at least one of secondary component carriers

$${\hat{H}}_{S}^{U E} ( t 1 )$$

is based on the channel state information reference signal CSI-RS(t1) on the at least one of secondary component carriers.

Means for obtaining the prediction of channel state information for the primary component carrier

$${\tilde{H}}_{P}^{gNB} ( t 2 )$$

and the prediction or channel state information for the at least one of secondary component carriers

$${\tilde{H}}_{S}^{gNB} ( t 2 )$$

based on at least one of the prediction of the common part

$${\tilde{H}}_{PS}^{gNB} ( t 1 )$$

and the update Δₜ₁ may comprise means for obtaining an updated common part H̅_{PS}(t1) based on at least one of the prediction of the common part

$${\tilde{H}}_{PS}^{gNB} ( t 1 )$$

and an update Δₜ₁; and means for providing an uncompressed or compressed updated common part Q(H̅_{PS}(t1)) to a second machine learning model to obtain the prediction of channel state information for the primary component carrier

$${\tilde{H}}_{P}^{gNB} ( t 2 )$$

and the prediction of channel state information for the at least one of secondary component carriers.

$${\tilde{H}}_{S}^{gNB} ( t 2 ) .$$

Means for obtaining the updated common part H̅_{PS}(t1) based on at least one of the prediction of the common part

$${\tilde{H}}_{PS}^{gNB} ( t 1 )$$

and the update Δₜ₁ may comprise: means for obtaining the updated common part H̅_{PS}(t1) based on the prediction of the common part

$${\tilde{H}}_{PS}^{gNB} ( t 1 ) .$$

Means for obtaining the updated common part H̅_{PS}(t1) based on at least one of the prediction of the common part

$${\tilde{H}}_{PS}^{gNB} ( t 1 )$$

and the update Δₜ₁ may comprise: means for and obtaining the common part H̅_{PS}(t1) based on the prediction of the common part

$${\tilde{H}}_{PS}^{gNB} ( t 1 )$$

the update Δₜ₁.

The base station may comprise: means for receiving, from the user equipment, an update Δₜ₂ between a prediction of a common part

$${\tilde{H}}_{PS}^{UE} ( t 2 )$$

and a common part

$${\hat{H}}_{PS}^{UE} ( t 2 )$$

between channel state information for the primary component carrier

$${\hat{H}}_{P}^{UE} ( t 2 )$$

and channel information for the at least one of secondary component carriers

$${\hat{H}}_{S}^{UE} ( t 2 ) ,$$

wherein channel state information for the primary component carrier

$${\hat{H}}_{P}^{UE} ( t 2 )$$

is based on the channel state information reference signal CSI-RS(t2) on the primary component carrier, and channel state information for the at least on of secondary component carriers

$${\hat{H}}_{S}^{UE} ( t 2 )$$

is based on the channel state information reference signal CSI-RS(t2) on the at least one of secondary component carriers.

The base station may comprise: means for transmitting, to the user equipment, a request to receive user equipment capability information indicating whether the user equipment supports machine learning models for managing channel state information feedback.

The base station may comprise: means for receiving, from the user equipment, user equipment capability information indicating the user equipment supports machine learning models for managing channel state information feedback.

The base station may comprise: means for receiving, from the user equipment, at least one of characteristics of a first machine learning model or characteristics of a training data set.

The characteristics of the first machine learning model may comprise at least one of a number of layers of a neural network and/or a number of nodes per layer of a neural network; and/or the characteristics of the training data set may comprise a length of the training data set to train the first machine learning model.

According to an aspect there is provided a method comprising: transmitting, to a user equipment, a channel state information reference signal CSI-RS(t0) on a primary component carrier and on at least one of secondary component carriers; and receiving, from the user equipment, an uncompressed or a compressed common part

$$Q ( {\hat{H}}_{PS}^{UE} ( t 0 ) )$$

between channel state information for the primary component carrier

$${\hat{H}}_{P}^{UE} ( t 0 )$$

and channel state information for the at least one of secondary component carriers

$${\hat{H}}_{S}^{UE} ( t 0 ) ,$$

wherein channel state information for the primary component carrier

$${\hat{H}}_{P}^{UE} ( t 0 )$$

is based on the channel state information reference signal CSI-RS(t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

The method may comprise: providing, the uncompressed or compressed common part

$$Q ( {\hat{H}}_{PS}^{UE} ( t 0 ) )$$

as an input to a second machine learning model to output a prediction of channel state information for a primary component carrier

$${\tilde{H}}_{P}^{gNB} ( t 1 )$$

and a prediction of channel state information for a secondary component carriers

$${\tilde{H}}_{S}^{gNB} ( t 1 ) ;$$

and obtaining, a prediction of a common part

$${\tilde{H}}_{PS}^{gNB} ( t 1 )$$

between a prediction of channel state information for the primary component carrier

$${\tilde{H}}_{P}^{gNB} ( t 1 )$$

and a prediction of channel state information for the at least one of secondary component carriers

$${\tilde{H}}_{S}^{gNB} ( t 1 )$$

based on the prediction of channel state information for the primary component carrier

$${\tilde{H}}_{P}^{gNB} ( t 1 )$$

and the prediction of channel state information for the at least one of secondary component carriers

$${\tilde{H}}_{S}^{gNB} ( t 1 ) .$$

The method may comprise: obtaining a prediction of channel state information for the primary component carrier

$${\tilde{H}}_{P}^{gNB} ( t 2 )$$

and a prediction of channel state information for the at least one of secondary component carriers

$${\tilde{H}}_{S}^{gNB} ( t 2 )$$

based on at least one of the prediction of the common part

$${\tilde{H}}_{PS}^{gNB} ( t 1 )$$

and an update Δₜ₁.

The method may comprise: transmitting, to the user equipment, a first threshold and/or a second threshold.

The method may comprise: receiving, from the user equipment, an update Δₜ₁ between a prediction of a common part and a common part

$${\tilde{H}}_{PS}^{UE} ( t 1 )$$

and a common part

$${\hat{H}}_{PS}^{UE} ( t 1 )$$

between channel state information for a primary component carrier

$${\hat{H}}_{P}^{UE} ( t 1 )$$

and channel state information for the at least one of secondary component carriers

$${\hat{H}}_{S}^{UE} ( t 1 ) ,$$

wherein channel state information for the primary component carrier

$${\hat{H}}_{P}^{UE} ( t 1 )$$

is based on the channel state information reference signal CSI-RS(t1) on the primary component carrier, and channel state information for the at least one of secondary component carriers

$${\hat{H}}_{S}^{UE} ( t 1 )$$

is based on the channel state information reference signal CSI-RS(t1) on the at least one of secondary component carriers.

Obtaining the prediction of channel state information for the primary component carrier

$${\tilde{H}}_{P}^{gNB} ( t 2 )$$

and the prediction of channel state information for the at least one of secondary component carriers

$${\tilde{H}}_{S}^{gNB} ( t 2 )$$

based on at least one of the prediction of the common part

$${\tilde{H}}_{PS}^{gNB} ( t 1 )$$

and the update Δₜ₁ may comprise obtaining an updated common part H̅_{PS}(t1) based on at least one of the prediction of the common part

$${\tilde{H}}_{PS}^{gNB} ( t 1 )$$

and an update Δₜ₁; and providing an uncompressed or compressed updated common Q(H̅_{PS}(t1)) to a second machine learning model to obtain the prediction of channel state information for the primary component carrier

$${\tilde{H}}_{P}^{gNB} ( t 2 )$$

and the prediction of channel state information for the at least one of secondary component carriers

$${\tilde{H}}_{S}^{gNB} ( t 2 ) .$$

Obtaining the updated common part H̅_{PS}(t1) based on at least one of the prediction of the common part

$${\tilde{H}}_{PS}^{gNB} ( t 1 )$$

and the update Δₜ₁ may comprise: obtaining the updated common part H̅_{PS}(t1) based on the prediction of the common part

$${\tilde{H}}_{PS}^{gNB} ( t 1 ) .$$

Obtaining the updated common part H̅_{PS}(t1) based on at least one of the prediction of the common part

$${\tilde{H}}_{PS}^{gNB} ( t 1 )$$

and the update Δₜ₁ may comprise: obtaining the common part H̅_{PS}(t1) based on the prediction of the common part

$${\tilde{H}}_{PS}^{gNB} ( t 1 )$$

and the update Δₜ₁.

The method may comprise: receiving, from the user equipment, an update Δₜ₂ between a prediction of a common part

$${\tilde{H}}_{PS}^{UE} ( t 2 )$$

and a common part

$${\hat{H}}_{PS}^{UE} ( t 2 )$$

between channel state information for a primary component carrier

$${\hat{H}}_{P}^{UE} ( t 2 )$$

and channel state information for the at least one of secondary component carriers

$${\hat{H}}_{S}^{U E} ( t 2 ) ,$$

wherein channel state information for the primary component carriers

$${\hat{H}}_{P}^{UE} ( t 2 )$$

is based on the channel state information reference signal CSI-RS(t2) on the primary component carrier, and channel state information for the at least one of secondary component carriers

$${\hat{H}}_{S}^{UE} ( t 2 )$$

is based on the channel state information reference signal CSI-RS(t2) on the at least one of secondary component carriers

The method may comprise: transmitting, to the user equipment, a request to receive user equipment capability information indicating whether the user equipment supports machine learning models for managing channel state information feedback.

The method may comprise: receiving, from the user equipment, user equipment capability information indicating the user equipment supports machine learning models for managing channel state information feedback.

The method may comprise: receiving, from the user equipment, at least one of characteristics of a first machine learning model or characteristics of a training data set.

The characteristics of the first machine learning model may comprise at least one of a number of layers of a neural network and/or a number of nodes per layer of a neural network; and/or the characteristics of the training data set may comprise a length of the training data set to train the first machine learning model.

According to an aspect there is provided a base station comprising at least one processor and at least one memory storing instructions that, when executed by the at least one processor, cause the apparatus at least to perform: transmitting, to a user equipment, a channel state information reference signal CSI-RS(t0) on a primary component carrier and on at least one of secondary component carriers; and receiving, from the user equipment, an uncompressed or a compressed common part

$$Q ( {\hat{H}}_{PS}^{UE} ( t 0 ) )$$

between channel state information for the primary component carrier

$${\hat{H}}_{P}^{UE} ( t 0 )$$

and channel state information for the at least one of secondary component carriers

$${\hat{H}}_{S}^{UE} ( t 0 ) ,$$

wherein channel state information for the primary component carrier

$${\hat{H}}_{P}^{UE} ( t 0 )$$

$${\hat{H}}_{S}^{UE} ( t 0 )$$

is based on the channel state information reference signal CSI-RS(t0) on the at least one of secondary component carriers.

According to an aspect there is provided a base station comprising circuitry configured to perform: transmitting, to a user equipment, a channel state information reference signal CSI-RS(t0) on a primary component carrier and on at least one of secondary component carriers; and receiving, from the user equipment, an uncompressed or a compressed common part

$$Q ( {\hat{H}}_{PS}^{UE} ( t 0 ) )$$

between channel state information for the primary component carrier

$${\hat{H}}_{P}^{UE} ( t 0 )$$

and channel state information for the at least one of secondary component carriers

$${\hat{H}}_{S}^{UE} ( t 0 ) ,$$

wherein channel state information for the primary component carrier

$${\hat{H}}_{P}^{UE} ( t 0 )$$

is based on the channel state information reference signal CSI-RS(t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

According to an aspect there is provided a computer program comprising computer executable code which when run on at least one processor is configured to perform: transmitting, to a user equipment, a channel state information reference signal CSI-RS(t0) on a primary component carrier and on at least one of secondary component carriers; and receiving, from the user equipment, an uncompressed or a compressed common part

$$Q ( {\hat{H}}_{PS}^{UE} ( t 0 ) )$$

between channel state information for the primary component carrier

$${\hat{H}}_{P}^{UE} ( t 0 )$$

and channel state information for that at least one of secondary component carriers

$${\hat{H}}_{S}^{UE} ( t 0 ) ,$$

wherein channel state information for the primary component carrier

$${\hat{H}}_{P}^{UE} ( t 0 )$$

is based on the channel state information reference signal CSI-RS(t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

According to an aspect there is provided a user equipment comprising: means for receiving, from a base station, a request to receive user equipment capability information indicating whether the user equipment supports machine learning models for managing channel state information feedback; and means for transmitting, to the base station, user equipment capability information indicating the user equipment supports machine learning models for managing channel state information feedback.

The user equipment may comprise: means for transmitting, to the base station, at least one of characteristics of a first machine learning model or characteristics of a training data set.

The characteristics of the first machine learning model may comprise at least one of a number of layers of a neural network or a number of nodes per layer of a neural network; and/or the characteristics of the training data set comprise a length of the training data set to train the first machine learning model.

The user equipment may comprise: means for obtaining a training data set, wherein each data entry of the training data set comprises an uncompressed or compressed common part

$$Q ( {\hat{H}}_{PS}^{UE} ( t n ) ) ,$$

channel state information for a primary component carrier

$${\hat{H}}_{P}^{UE} ( t n )$$

and channel state information for at least one of secondary component carriers

$${\hat{H}}_{S}^{UE} ( tn ) .$$

The user equipment may comprise a first machine model trained based on the training data set to output a prediction of a common part

$${\tilde{H}}_{PS}^{UE} ( tn + 1 )$$

between channel state information for a primary component carrier

$${\hat{H}}_{P}^{UE} ( t n )$$

and channel state information for at least one of secondary component carriers

$${\hat{H}}_{S}^{UE} ( tn )$$

when provided an uncompressed or compressed common part

$$Q ( {\hat{H}}_{PS}^{UE} ( tn ) )$$

as an input.

The user equipment may comprise: means for transmitting, to the base station, the training data set so that the base station trains a second machine learning model based on the data set to output a prediction of channel state information for a primary component carrier

$${\tilde{H}}_{P}^{gNB} ( tn )$$

and a predication of channel state information for at least one of secondary component carriers

$${\tilde{H}}_{S}^{gNB} ( tn )$$

when provided an uncompromised or compressed common part

$$Q ( {\hat{H}}_{PS}^{UE} ( tn ) )$$

as an input.

The user equipment may comprise: means for receiving, from a base station, a channel state information reference signal CSI-RS(t0) on a primary component carrier and on at least one of secondary component carriers; and means for transmitting, to the base station, an uncompressed or a compressed common part

$$Q ( {\hat{H}}_{PS}^{UE} ( t 0 ) )$$

between channel State information for the primary component carrier

$${\hat{H}}_{P}^{UE} ( t 0 )$$

and channel state information for the at least one of secondary component carrier

$${\hat{H}}_{S}^{UE} ( t 0 ) ,$$

wherein channel state information for the primary component carrier

$${\hat{H}}_{P}^{UE} ( t 0 )$$

is based on the channel state information reference signal CSI-RS(t0) on the primary component carrier, and channel state information for the at least one of secondary component carriers

$${\hat{H}}_{S}^{UE} ( t 0 )$$

is based on the channel state information reference signal CSI-RS(t0) on the at least one of secondary component carriers.

The user equipment may comprise: means for transmitting, to the base station, an update Δₜ₁ between a prediction of a common part

$${\tilde{H}}_{PS}^{UE} ( t 1 )$$

and a common part

$${\hat{H}}_{PS}^{UE} ( t 1 )$$

between channel state information for a primary component carrier

$${\hat{H}}_{P}^{UE} ( t 1 )$$

and channel state information for at least one of secondary component carriers

$${\hat{H}}_{S}^{UE} ( t 1 ) ,$$

wherein channel state information for the primary component carrier

$${\hat{H}}_{P}^{UE} ( t 1 )$$

is based on the channel state information reference signal CSI-RS(t1) on the primary component carrier, and channel state information for the at least one of secondary component carriers is based on the

$${\hat{H}}_{S}^{UE} ( t 1 )$$

is based on the channel state information reference signal CSI-RS(t1) on the at least one of secondary component carriers.

Channel state information for a primary component carrier

$${\hat{H}}_{P}^{UE} ( t 1 )$$

may comprise a first vector of elements.

The first vector of elements may comprise at least one of: a rank indicator element; a pre-coding matrix indicator element or a channel quality indicator element.

Channel state information for at least one of secondary component carriers

$${\hat{H}}_{S}^{UE} ( t 1 )$$

may comprise a second vector of elements.

The second vector of elements may comprise at least one of: a rank indicator element; a pre-coding matrix indicator element or a channel quality indicator element.

The common part

$${\hat{H}}_{PS}^{UE} ( t 1 )$$

between channel state information for a primary component carrier

$${\hat{H}}_{P}^{UE} ( t 1 )$$

and channel state information for at least one of secondary component carriers

$${\hat{H}}_{S}^{UE} ( t 1 )$$

may comprise a third vector of elements.

The third vector of elements may comprise at least one of: elements present in the first vector of elements and present in the second vector of elements; or elements present in the first vector of elements differing from elements present in the second vector of elements by less than a threshold.

The user equipment may comprise: means for providing the uncompressed or compressed common part

$$Q ( {\hat{H}}_{P S}^{U E} ( t 0 ) )$$

as an input to a first machine learning model to output the prediction of the common part

$${\tilde{H}}_{P S}^{U E} ( t 1 ) ;$$

and/or means for providing an uncompressed or compressed common part

$$Q ( {\hat{H}}_{P S}^{U E} ( t 1 ) )$$

to a first machine learning model to output a prediction of a common part

$${\tilde{H}}_{P S}^{U E} ( t 2 ) .$$

The update Δₜ₁ between the prediction of the common part

$${\tilde{H}}_{P S}^{U E} ( t 1 )$$

and the common part

$${\hat{H}}_{P S}^{U E} ( t 1 )$$

may comprise a difference between the predication of the common part

$${\tilde{H}}_{P S}^{U E} ( t 1 )$$

and the common part

$${\hat{H}}_{P S}^{U E} ( t 1 ) .$$

The user equipment may comprise: means for providing an uncompressed or compressed prediction of the common part

$$Q ( {\tilde{H}}_{P S}^{U E} ( t 1 ) )$$

to a first machine learning model to obtain a prediction of a common part

$${\tilde{H}}_{P S}^{U E} ( t 2 ) .$$

The user equipment may comprise: means for obtaining, a common part

$${\hat{H}}_{P S}^{U E} ( t 2 )$$

between channel state information for the primary component carrier

$${\hat{H}}_{P}^{U E} ( t 2 )$$

and channel state information for the at least one of secondary component carriers

$${\hat{H}}_{S}^{U E} ( t 2 ) ;$$

means for obtaining, by the user equipment, and update Δₜ₂ between the prediction of the common part

$${\tilde{H}}_{P S}^{U E} ( t 2 )$$

and the common part

$${\hat{H}}_{P S}^{U E} ( t 2 ) ;$$

and transmitting, by the user equipment to the base station, the update Δₜ₂.

Means for transmitting, to the base station, an update Δₜ₁ between a prediction of a common part

$${\tilde{H}}_{P S}^{U E} ( t 1 )$$

and a common part

$${\hat{H}}_{P S}^{U E} ( t 1 )$$

between channel state information for a primary component carrier

$${\hat{H}}_{P}^{U E} ( t 1 )$$

and channel state information for at least one of secondary component carriers

$${\hat{H}}_{S}^{U E} ( t 1 )$$

and/or the update Δₜ₂ between the prediction of a common part

$${\tilde{H}}_{P S}^{U E} ( t 2 )$$

and the common part

$${\hat{H}}_{P S}^{U E} ( t 2 )$$

between channel state information for a primary component carrier

$${\hat{H}}_{P}^{U E} ( t 2 )$$

and channel state information for at least one of secondary component carrier

$${\hat{H}}_{S}^{U E} ( t 2 )$$

may comprise: means for transmitting, to the base station, the update Δₜ₁ between the prediction of a common part

$${\tilde{H}}_{P S}^{U E} ( t 1 )$$

and the common part

$${\hat{H}}_{P S}^{U E} ( t 1 )$$

based on the update Δₜ₁ and a first threshold; and/or means for transmitting, to the base station, the update Δₜ₂ between the prediction of a common part

$${\tilde{H}}_{PS}^{UE} ( t 2 )$$

and the common part

$${\hat{H}}_{PS}^{UE} ( t 2 )$$

based on the update Δₜ₂ and second threshold.

Means for transmitting, to the base station, the update Δₜ₁ between the prediction of a common part

$${\tilde{H}}_{PS}^{UE} ( t 1 )$$

and the common part

$${\hat{H}}_{PS}^{UE} ( t 1 )$$

based on the update Δₜ₁ and the first threshold may comprise: means for transmitting, to the base station, the update Δₜ₁, when the update Δₜ₁ is greater than the first threshold; or means for not transmitting, to the base station, the update Δₜ₁, when the update Δₜ₁ is smaller than the first threshold.

Means for transmitting, to the base station, an update Δₜ₂ between the prediction of a common part

$${\tilde{H}}_{PS}^{UE} ( t 2 )$$

and the common part

$${\hat{H}}_{PS}^{UE} ( t 2 )$$

based on the update Δₜ₂ and the second threshold may comprise: means for transmitting, to the base station, the update Δₜ₂, when the update Δₜ₂ is greater than the second threshold; or means for not transmitting, to the base station, the update Δₜ₂, when the update Δₜ₂ is smaller than the second threshold.

According to an aspect there is provided a method comprising: receiving, from a base station, a request to receive user equipment capability information indicating whether the user equipment supports machine learning models for managing channel state information feedback; and transmitting, to the base station, user equipment capability information indicating the user equipment supports machine learning models for managing channel state information feedback.

The method may comprise: transmitting, to the base station, at least one of characteristics of a first machine learning model or characteristics of a training data set.

The characteristics of the first machine learning model may comprise at least one of a number of layers of a neural network or a number of nodes per layer of a neural network; and/or the characteristics of the training data set comprise a length of the training data set to train the first machine learning model.

The method may comprise: obtaining a training data set, wherein each data entry of the training data set comprises an uncompressed or compressed common pant

$$Q ( {\hat{H}}_{PS}^{UE} ( tn ) ) ,$$

channel state information for a primary component carrier

$${\hat{H}}_{P}^{UE} ( tn )$$

and channel state for at least one of secondary component carriers

$${\hat{H}}_{S}^{UE} ( tn ) .$$

The method may be performed by a user equipment.

The user equipment may comprise a first machine model trained based on the training data set to output a prediction of a common part

$${\tilde{H}}_{PS}^{UE} ( tn + 1 )$$

between channel state information for a primary component carrier

$${\hat{H}}_{P}^{UE} ( tn )$$

and channel state information for at least one of secondary component carriers

$${\hat{H}}_{S}^{UE} ( tn )$$

when provided an uncompressed or compressed common part

$$Q ( {\hat{H}}_{PS}^{UE} ( tn ) )$$

as an input.

The method may comprise: transmitting, to the base station, the training data set so that the base station trains a second machine learning model based on the data set to output a prediction of channel state information for a primary component carrier

$${\tilde{H}}_{P}^{gNB} ( tn )$$

and a prediction of channel state information for at least one of secondary component carriers

$${\tilde{H}}_{S}^{gNB} ( tn )$$

when provided an uncompressed or compressed common pail

$$Q ( {\hat{H}}_{P S}^{UE} ( tn ) )$$

as an input.

The method may comprise: receiving, from a base station, a channel state information reference signal CSI-RS(t0) on a primary component carrier and on at least one of secondary component carriers; and means for transmitting, to the base station, an uncompressed or a compressed common part

$$Q ( {\hat{H}}_{P S}^{U E} ( t 0 ) )$$

between channel state information for the primary component carrier

$${\hat{H}}_{P}^{U E} ( t 0 )$$

and channel state information for the at least one of secondary component carrier

$${\hat{H}}_{S}^{U E} ( t 0 ) ,$$

wherein channel state information for the primary component carriers

$${\hat{H}}_{P}^{U E} ( t 0 )$$

is based on the channel state information reference signal CSI-RS(t0) on the primary component carrier, and channel state information for the at least one of secondary component carriers

$${\hat{H}}_{S}^{U E} ( t 0 )$$

is based on the channel state information reference signal CSI-RS(t0) on the at least one of secondary component carriers. RS (t0) on the at least one of secondary component carriers.

The method may comprise: transmitting, to the base station, an update Δₜ₁ between a prediction of a common part

$${\tilde{H}}_{P S}^{U E} ( t 1 )$$

and a common part

$${\hat{H}}_{P S}^{U E} ( t 1 )$$

between channel state information for a primary component carrier

$${\hat{H}}_{P}^{U E} ( t 1 )$$

and channel state information for at least one of secondary component carriers

$${\hat{H}}_{S}^{U E} ( t 1 ) ,$$

wherein channel state information for the primary component carrier

$${\hat{H}}_{P}^{U E} ( t 1 )$$

is based on the channel state information reference signal CSI-RS(t1) on the primary component carrier, and channel state information for the at least one of secondary component carriers

$${\hat{H}}_{S}^{U E} ( t 1 )$$

is based on the channel state information reference signal CSI-RS(t1) on the at least one of secondary component carriers.

Channel state information for a primary component carrier

$${\hat{H}}_{P}^{UE} ( t 1 )$$

may comprise a first vector of elements.

The first vector of elements may comprise at least one of: a rank indicator element; a pre-coding matrix indicator element or a channel quality indicator element.

Channel state information for at least one of secondary component carriers

$${\hat{H}}_{S}^{UE} ( t 1 )$$

may comprise a second vector of elements.

The second vector of elements may comprise at least one of: a rank indicator element; a pre-coding matrix indicator element or a channel quality indicator element.

The common part

$${\hat{H}}_{PS}^{UE} ( t 1 )$$

between channel state information for a primary component carrier

$${\hat{H}}_{P}^{UE} ( t 1 )$$

and channel state information for at least one of secondary component carriers

$${\hat{H}}_{S}^{UE} ( t 1 )$$

may comprise a third vector of elements.

The third vector of elements may comprise at least one of: elements present in the first vector of elements and present in the second vector of elements; or elements present in the first vector of elements differing from elements present in the second vector of elements by less than a threshold.

The method may comprise: providing the uncompressed or compressed common part

$$Q ( {\hat{H}}_{PS}^{UE} ( t 0 ) )$$

as an input to a first machine learning model to output the prediction of the common part

$${\tilde{H}}_{PS}^{UE} ( t 1 ) ;$$

and/or providing an uncompressed or compressed common part

$$Q ( {\hat{H}}_{PS}^{UE} ( t 1 ) )$$

to a first machine learning model to output a prediction of a common part

$${\tilde{H}}_{PS}^{UE} ( t 2 ) .$$

The update Δₜ₁ between the prediction of the common part

$${\tilde{H}}_{PS}^{UE} ( t 1 )$$

and the common part

$${\hat{H}}_{PS}^{UE} ( t 1 )$$

may comprise a difference between the prediction of the common part

$${\tilde{H}}_{PS}^{UE} ( t 1 )$$

and the common part

$${\hat{H}}_{PS}^{UE} ( t 1 ) .$$

The method may comprise: providing an uncompressed or compressed prediction of the common part

$$Q ( {\tilde{H}}_{PS}^{U E} ( t 1 ) )$$

to a first machine learning model to obtain a prediction of a common part

$${\tilde{H}}_{PS}^{UE} ( t 2 ) .$$

The method may comprise: obtaining, a common part

$${\hat{H}}_{PS}^{UE} ( t 2 )$$

between channel State information for the primary component carrier

$${\hat{H}}_{P}^{UE} ( t 2 )$$

and channel state information for the at least one of secondary component carriers

$${\hat{H}}_{S}^{UE} ( t 2 ) ;$$

obtaining, by the user equipment, an update Δₜ₂ between the prediction of the common part

$${\tilde{H}}_{PS}^{UE} ( t 2 )$$

and the common part

$${\hat{H}}_{PS}^{UE} ( t 2 ) ;$$

and transmitting, by the user equipment to the base station, the update Δₜ₂.

Transmitting, to the base station, an update Δₜ₁ between a prediction of a common part

$${\tilde{H}}_{PS}^{UE} ( t 1 )$$

and a common part

$${\hat{H}}_{PS}^{UE} ( t 1 )$$

between channel state information for a primary component carrier

$${\hat{H}}_{P}^{UE} ( t 1 )$$

and channel state information for at least one of secondary component carriers

$${\hat{H}}_{S}^{UE} ( t 1 )$$

and/or the update Δₜ₂ between the prediction of a common part

$${\tilde{H}}_{PS}^{UE} ( t 2 )$$

and the common part

$${\hat{H}}_{PS}^{UE} ( t 2 )$$

between channel state information for a primary component carrier

$${\hat{H}}_{P}^{UE} ( t 2 )$$

and channel state information for at least one of secondary component carriers

$${\hat{H}}_{S}^{UE} ( t 2 )$$

may comprise: transmitting, to the base station, the update Δₜ₁ between the prediction of a common part

$${\tilde{H}}_{PS}^{UE} ( t 1 )$$

and the common part

$${\hat{H}}_{PS}^{UE} ( t 1 )$$

based on the update Δₜ₁ and a first threshold; and/or transmitting, to the base station, the update Δₜ₂ between the prediction of a common part

$${\tilde{H}}_{PS}^{UE} ( t 2 )$$

and the common part

$${\hat{H}}_{PS}^{UE} ( t 2 )$$

based on the update Δₜ₂ and a second threshold.

The method may comprise: obtaining the first threshold and/or second threshold based on a received configuration or pre-configuration.

Transmitting, to the base station, the update Δₜ₁ between the prediction of a common part

$${\tilde{H}}_{PS}^{UE} ( t 1 )$$

and the common part

$${\hat{H}}_{PS}^{UE} ( t 1 )$$

based on the update Δₜ₁ and the first threshold may comprise: transmitting, to the base station, the update Δₜ₁, when the update Δₜ₁ is greater than the first threshold; or means for not transmitting, tot he base station, the update Δₜ₁, when the update Δₜ₁ is smaller than the first threshold.

Transmitting, to the base station, the update Δₜ₂ between the prediction of a common part

$${\tilde{H}}_{PS}^{UE} ( t 2 )$$

and the common part

$${\hat{H}}_{PS}^{UE} ( t 2 )$$

based on the update Δₜ₂ and the second threshold may comprise: transmitting, to the base station, the update Δₜ₂, when the update Δₜ₂ is greater than the second threshold; or means for not transmitting, to the base station, the update Δₜ₂, when the update Δₜ₂ is smaller than the second threshold.

According to an aspect there is provided a user equipment comprising at least one processor and at least one memory storing instructions that, when executed by the at least one processor, cause the apparatus at least to perform: receiving, from a base station, a request to receive user equipment capability information indicating whether the user equipment supports machine learning models for managing channel state information feedback; and transmitting, to the base station, user equipment capability information indicating the user equipment supports machine learning models for managing channel state information feedback.

According to an aspect there is provided a user equipment comprising circuitry configured to perform receiving, from a base station, a request to receive user equipment capability information indicating whether the user equipment supports machine learning models for managing channel state information feedback; and transmitting, to the base station, user equipment capability information indicating the user equipment supports machine learning models for managing channel state information feedback.

According to an aspect there is provided a computer program comprising computer executable code which when run on at least one processor is configured to perform: receiving, from a base station, a request to receive user equipment capability information indicating whether the user equipment supports machine learning models for managing channel state information feedback; and transmitting, to the base station, user equipment capability information indicating the user equipment supports machine learning models for managing channel state information feedback.

According to an aspect there is provided a base station comprising: means for transmitting, to a user equipment, a request to receive user equipment capability information indicating whether the user equipment supports machine learning models for managing channel state information feedback; and means for receiving, from the user equipment, user equipment capability information indicating the user equipment supports machine learning models for managing channel state information feedback.

The base station may comprise: means for receiving, from the user equipment, at least one of characteristics of a first machine learning model or characteristics of a training data set.

The characteristics of the first machine learning model may comprise at least one of a number of layers of a neural network and/or a number of nodes per layer of a neural network; and/or the characteristics of the training data set may comprise a length of the training data set to train the first machine learning model.

The base station may comprise: means for receiving, from the user equipment, a training data set, wherein each data entry of the training data set comprises an uncompressed or compressed common part

$$Q ( {\hat{H}}_{PS}^{UE} ( tn ) ) ,$$

channel state information for a primary component carrier

$${\hat{H}}_{P}^{UE} ( tn )$$

and channel state information for at least one of secondary component carriers

$${\hat{H}}_{S}^{UE} ( tn ) ;$$

and the base station may comprise, a second machine learning model trained based on the training data set to output a prediction of channel state information for a primary component carrier

$${\tilde{H}}_{P}^{gNB} ( tn )$$

and a prediction of channel state information for the at least on one of secondary component carriers

$${\tilde{H}}_{S}^{gNB} ( tn )$$

when provided an uncompressed or compressed common part

$$Q ( {\hat{H}}_{PS}^{UE} ( tn ) )$$

as an input.

According to an aspect there is provided a method comprising: transmitting, to a user equipment, a request to receive user equipment capability information indicating whether the user equipment supports machine learning models for managing channel state information feedback; and receiving, from the user equipment, user equipment capability information indicating the user equipment supports machine learning models for managing channel state information feedback.

The method may comprise: receiving, from the user equipment, at least one of characteristics of a first machine learning model or characteristics of a training data set.

The characteristics of the first machine learning model may comprise at least one of a number of layers of a neural network and/or a number of nodes per layer of a neural network; and/or the characteristics of the training data set may comprise a length of the training data set to train the first machine learning model.

The method may be performed by a base station.

The method may comprise: means for receiving, from the user equipment, a training data set, wherein each data entry of the training data set comprises an uncompressed or compressed common part

$$Q ( {\hat{H}}_{PS}^{UE} ( tn ) ) ,$$

channel state information for a primary component carrier

$${\hat{H}}_{P}^{UE} ( tn )$$

and channel state information for at least one of secondary component carriers

$${\hat{H}}_{S}^{UE} ( tn ) ;$$

and the base station may comprise, a second machine learning model trained based on the training data set to output a prediction of channel state information for a primary component carrier

$${\tilde{H}}_{P}^{gNB} ( tn )$$

and a prediction of channel state information for the at least one of secondary component carriers

$${\tilde{H}}_{S}^{gNB} ( tn )$$

when provided an uncompressed or compressed common part

$$Q ( {\hat{H}}_{PS}^{UE} ( tn ) )$$

as an input.

According to an aspect there is provided a base station comprising at least one processor and at least one memory storing instructions that, when executed by the at least one processor, cause the apparatus at least to perform: transmitting, to a user equipment, a request to receive user equipment capability information indicating whether the user equipment supports machine learning models for managing channel state information feedback; and receiving, from the user equipment, user equipment capability information indicating the user equipment supports machine learning models for managing channel state information feedback.

According to an aspect there is provided a base station comprising circuitry configured to perform: transmitting, to a user equipment, a request to receive user equipment capability information indicating whether the user equipment supports machine learning models for managing channel state information feedback; and receiving, from the user equipment, user equipment capability information indicating the user equipment supports machine learning models for managing channel state information feedback.

According to an aspect there is provided a computer program comprising computer executable code which when run on at least one processor is configured to perform: transmitting, to a user equipment, a request to receive user equipment capability information indicating whether the user equipment supports machine learning models for managing channel state information feedback; and receiving, from the user equipment, user equipment capability information indicating the user equipment supports machine learning models for managing channel state information feedback.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
Al: Artificial Intelligence
AMF: Access and Mobility Management Function
BS: Base Station
CA: Carrier Aggregation
CSI: Channel State Information
CU: Centralized Unit
DL: Downlink
DU Distributed Unit
gNB: gNodeB
IoT Internet of Things
ML: Machine Learning
MS: Mobile Station
MTC: Machine Type Communication
NEF: Network Exposure Function
NF: Network Function
NR: New radio
NRF: Network Repository Function
PCC: Primary Component Carrier
RAM: Random Access Memory
(R)AN: (Radio) Access Network
ROM: Read Only Memory
SCC: Secondary Component Carrier
SMF: Session Management Function
UE: User Equipment
UL: Uplink
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a user equipment;

FIG. 4 shows an example of a flow diagram of a process, performed by a user equipment and a base station, for managing channel state information feedback;

FIG. 5 shows an example of a first vector of elements, a second vector of elements, a threshold and a third vector of elements determined by a function “commonPart”;

FIG. 6 shows an example of the code of the function “commonPart”;

FIG. 7 shows an example of a first artificial intelligence/machine learning model used by a user equipment and a second artificial intelligence/machine learning model used by a base station;

FIG. 8 shows an example of a signaling diagram of a process, performed by a user equipment and a base station, for managing channel state information feedback;

FIG. 9 shows an example of a block diagram of a method, performed by a user equipment, for managing channel state information feedback;

FIG. 10 shows an example of a block diagram of a method, performed by base station, for managing channel state information feedback;

FIG. 11 shows an example of a block diagram of a method, performed by a user equipment, for managing channel state information feedback;

FIG. 12 shows an example of a block diagram of a method, performed by base station, for managing channel state information feedback; and

FIG. 13 shows a schematic representation of a non-volatile memory medium storing instructions which when executed by a processor allow a processor to perform one or more of the steps of the methods of FIG. 9 to FIG. 12.

### DETAILED DESCRIPTION OF THE FIGURES

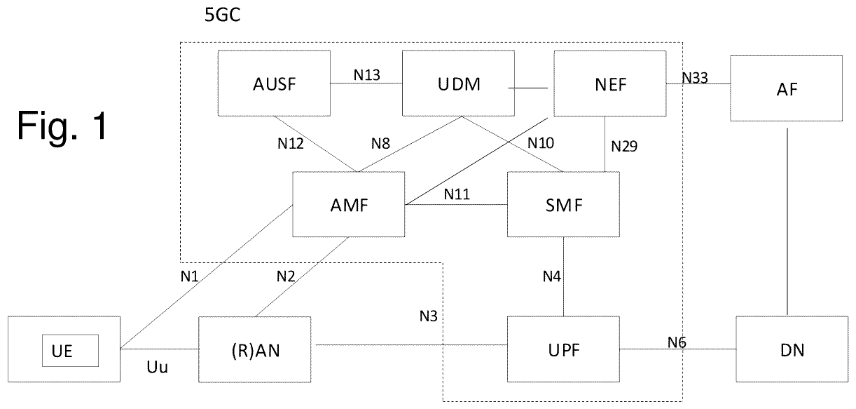

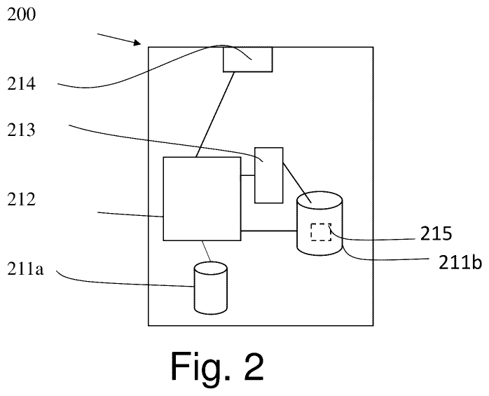

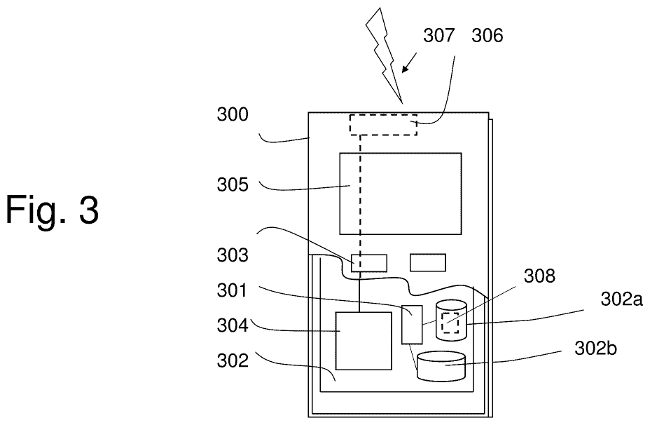

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIG. 1, FIG. 2 and FIG. 3 to assist in understanding the technology underlying the described examples.

Although one or more of the following aspects are described in relation to a 5G system (5GS), it will be understood one or more of the following aspects may be applicable to past generation systems or future generation systems.

FIG. 1 shows a schematic representation of a 5GS. The 5GS may comprises user equipment (UEs), a (radio) access network (R)AN), a 5G core network (5GC), one or more application functions (AF) and one or more data networks (DN). The 5G (R)AN may comprise one or more base stations (BSs). The BSs may comprise gNodeBs (gNBs). The gNodeBs may comprise one or more gNB distributed unit functions connected to one or more gNB centralized unit functions.

The 5GC may comprise an access and mobility management function (AMF), a session management function (SMF), an authentication server function (AUSF), a user data management (UDM), a user plane function (UPF), a network exposure function (NEF).

FIG. 2 illustrates an example of a control apparatus 200 for controlling a function of the (R)AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G (R)AN or the 5GC. In some embodiments, each function of the (R)AN or the 5GC comprises a control apparatus 200. In alternative embodiments, two or more functions of the (R)AN or the 5GC may share a control apparatus.

FIG. 3 illustrates an example of a user equipment 300, such as the terminal illustrated on FIG. 1. The UE 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (loT) device or any combinations of these or the like. The UE 300 may provide, for example, communication of data for carrying communications. The communications may be one or more of voice, electronic mail (email), text message, multimedia, data, machine data and so on.

The UE 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The UE 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Carrier aggregation (CA) may be a key functionality in a communication system where a very high bit rate communication can be achieved by aggregating multiple component carriers (CCs) at different centre frequencies and by transmitting simultaneously both in the downlink (DL) and the uplink (UL) on the multiple CCs. The multiple CC may comprise a primary component carrier (PCC) and one or more secondary component carriers (SCC(s)).

Reporting DL channel state information (CSI) may generate significant overhead as a UE may have to feedback CSI for the PCC and CSI for the SCC(s). An UL channel of the PCC may be used for reporting CSI for the SCC(s) and reduce overhead on the UL channel of the SCC(s). However, this may increase the overhead on the UL channel of the PCC. Alternatively, n UL channel of the SCC(s) may be used for reporting CSI for the SCC(s). However, this may increase the overhead on the UL channel of the SCC(s).

One or more aspect of this document provide aims an artificial intelligence (AI)/machine learning (ML) solution to manage CSI feedback.

One or more aspect of this document provide aims an artificial intelligence (AI)/machine learning (ML) solution to reduce overhead on the UL channel of the PCC or on the UL channel of the SCC(s).

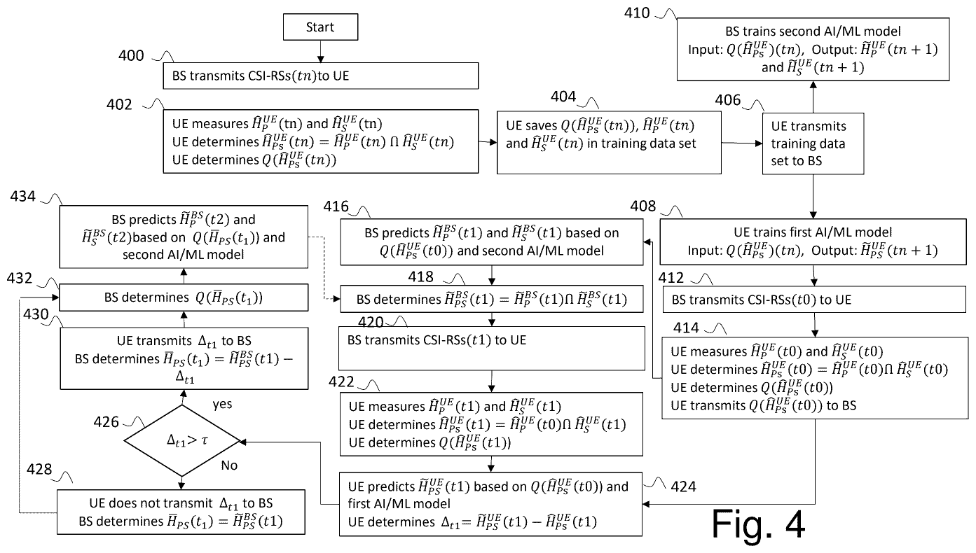

FIG. 4 shows an example of a flow diagram of a process, performed by a UE and a BS, for managing CSI feedback. The process may comprise a training phase and a use phase.

The description in the following can be used in the scenario where the UE supports CA and aggregates a PCC and a single SCC. Alternatively, the description in the following can be used in the scenario where the UE supports CA and aggregates a PCC and multiple SCCs in the same way.

### Training Phase

At step 400, the BS may transmit, to the UE, a CSI-RS(tn) on a PCC. The BS may transmit, to the UE, a CSI-RS (tn) on at least one of SCCs.

At step 400, the UE may measure CSI for the PCC

$${\hat{H}}_{P}^{UE} ( tn ) .$$

### The CSI for the PCC

$${\hat{H}}_{P}^{UE} ( tn )$$

may comprise a first vector of elements. The first vector of elements may comprise at least one of: a rank indicator element; a pre-coding matrix indicator element or a channel quality indicator element.

The UE may measure CSI for the at least one of the SCCs

$${\hat{H}}_{S}^{UE} ( tn ) .$$

The CSI for the at least one of the SCCs

$${\hat{H}}_{S}^{UE} ( tn )$$

may comprise a second vector of elements. The second vector of elements may comprise at least one of: a rank indicator element; a pre-coding matrix indicator element or a channel quality indicator element.

The UE may determine a common part

$${\hat{H}}_{P s}^{UE} ( tn )$$

between the CSI for the PCC

$${\hat{H}}_{P}^{UE} ( tn )$$

and the CSI for the at least one of the SCCs

$${\hat{H}}_{S}^{UE} ( tn ) .$$

The common part

$${\hat{H}}_{P S}^{UE} ( tn )$$

may comprise third vector of elements.

In an implementation, the UE may determine a third vector of elements using a common part function U_{c}. The function U_{c} may iterate each element of a first vector of elements and check if the element is present in a second vector of elements or differs from an element present in the second vector of elements by less than a threshold α. If the element is present in the second vector of elements or differs from an element present in the second vector of elements by less than the threshold a, the element is a common element and is included in the third vector of elements. The threshold a may be agreed with the base station. The function U_{c} may be expressed as follows.

$${U}_{c} ( {\hat{H}}_{P}^{UE} ( tn ) , {\hat{H}}_{S}^{UE} ( tn ) ) = {\hat{H}}_{Ps}^{UE} ( tn ) = {\hat{H}}_{P}^{UE} ( tn ) ⋂ {\hat{H}}_{S}^{UE} ( tn ) .$$

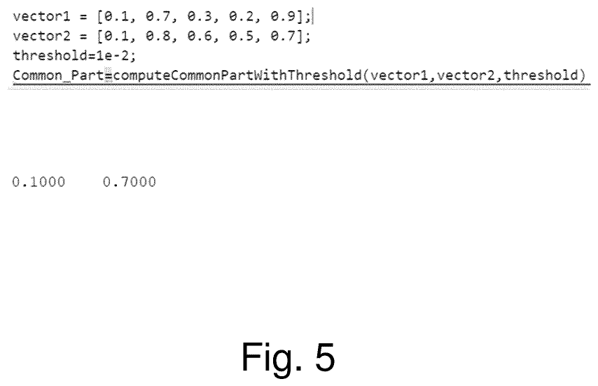

FIG. 5 shows an example of the first vector of elements, the second vector of element, the threshold and the third vector of elements determined by the function U_{c} (here “commonPart”).

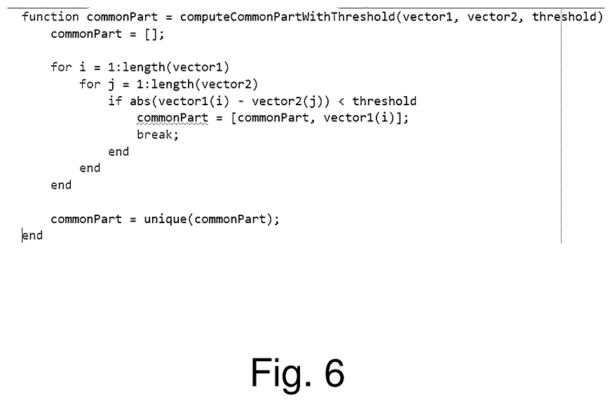

FIG. 6 shows an example of the code of the function U_{c} (here “commonPart”).

In another implementation, the UE may determine a third vector of elements using a common part function U_{c}. The function U_{c} may determine the intersection between a normalized eigenvector

$${E}_{v}^{P} ( tn )$$

of a first vector of elements and a normalized eigenvector

$${E}_{v}^{s} ( tn )$$

of a second vector of elements. Elements of the intersection may be included in the third vector of elements. The function U_{c} may be expressed as follows.

$${U}_{c} ( {\hat{H}}_{P}^{UE} ( tn ) , {\hat{H}}_{S}^{UE} ( tn ) ) = {\hat{H}}_{Ps}^{UE} ( tn ) = {E}_{v}^{P} ( tn ) ⋂ {E}_{v}^{s} ( tn )$$

In another implementation, the UE may determine a third vector of elements using a common part function U_{c}. The function U_{c} may determine the intersection between D^{P} and D^{S}. D^{P} may be the difference between a normalized eigenvector

$${E}_{v}^{P} ( tn )$$

of a first vector of elements and a normalized eigenvector

$${E}_{v}^{P} ( tn - 1 )$$

of a previous first vector of elements. D^{S} may be difference between a normalized eigenvector

$${E}_{v}^{s} ( tn )$$

of a second vector of elements and a normalized

$${E}_{v}^{s} ( tn )$$

of a previous second vector of elements. Elements of the intersections may be included in the third vector of elements. The function U_{c} may be expressed as follows.

$${U}_{c} ( {\hat{H}}_{P}^{UE} ( tn ) , {\hat{H}}_{S}^{UE} ( tn ) ) = {\hat{H}}_{P s}^{UE} ( tn ) = {D}^{P} ⋂ {D}^{S} \\ {D}^{P} = {E}_{v}^{P} ( tn ) - {E}_{v}^{P} ( tn - 1 ) \\ {D}^{S} = {E}_{v}^{S} ( tn ) - {E}_{v}^{S} ( tn - 1 )$$

In another implementation, the UE may determine a difference between a normalized eigenvector

$${E}_{v}^{P} ( tn )$$

of a first vector of elements and a normalized eigenvector

$${E}_{v}^{s} ( tn )$$

of a second vector of elements. If an element of the difference is zero, the element may be included in the third vector of elements.

In another implementation, the UE may compute a union of a first vector of element and a second vector of elements, which may give unique elements from both the first vector of element and the second vector of elements. An element from the union may be excluded from the third vector of elements. The UE may compute the difference between the first vector of element and the second vector of elements, which may give common elements from both the first vector of element and the second vector of elements. An element from the difference may be included in the third vector of elements.

In another implementation, the UE may sort the first vector of elements and the second vector of elements in ascending order. The UE may iterate through the first vector of elements and the second vector of elements simultaneously and may comparing the elements at each index. If the elements are identical or different by less than a threshold, the UE may include the element in the third vector of elements.

In another implementation, the UE may create a hash table or dictionary to store the elements of one of the first vector of elements and the second vector of elements. The UE may iterate through the other one of the first vector of elements and the second vector of elements. The UE may determine if each element is present in the hash table. If an element exist in present in the hash table, the UE may include the element in the third vector of elements.

The UE may compress the common part

$${\hat{H}}_{Ps}^{UE} ( tn ) .$$

The UE may compress the common part

$${\hat{H}}_{Ps}^{UE} ( tn )$$

using a quantization function Q to obtain a compressed common part

$$Q ( {\hat{H}}_{Ps}^{UE} ( tn ) ) .$$

It will be understood that, although in this document a compression operation is used to reduce the signaling overhead, such operation may be omitted.

The UE may save the compressed common part

$$Q ( {\hat{H}}_{Ps}^{UE} ( tn ) ) ,$$

### the CSI for the

$$PCC {\hat{H}}_{P}^{UE} ( tn )$$

and the CSI for the at least one of

$$SCCs {\hat{H}}_{S}^{UE} ( tn )$$

as a training data entry.

The BS and the UE may repeat steps 400, 402 and 404 L times to obtain L a training data entries forming a training data set of length L.

At step 406, the UE may transmit the training data set to the BS. The UE may transmit the training data set to the BS using at least one of an UL channel of the PCC or an UL channel of the at least one of SCCs.

At step 408, the UE may use the training dataset to train a first AI/ML model to output a prediction of the common part

$${\tilde{H}}_{PS}^{UE} ( tn + 1 )$$

in response to an uncompressed or compressed common part

$$Q ( {\hat{H}}_{Ps}^{UE} ( tn ) )$$

being input.

At step 410, the BS may use the training dataset to train a first AI/ML model to output a prediction of the CSI for the

$$PCC {\tilde{H}}_{P}^{gNB} ( tn + 1 )$$

and a prediction of the CSI for the at least one of

$$SCCs {\tilde{H}}_{S}^{gNB} ( tn )$$

in response to an uncompressed or compressed common part

$$Q ( {\hat{H}}_{Ps}^{UE} ( tn ) )$$

being input.

The first AI/ML model and the second AI/ML may be implemented using a neural network (e.g., recurrent neural network or an advanced version such as a long short term memory neural network).

It will be understood that the first AI/ML model is not necessarily trained internally by the UE. The first AI/ML model may be trained externally to the UE and received by the UE. Likewise, the second AI/ML model is not necessarily trained internally by the BS. The first AI/ML model may be trained externally to the BS and received by the BS.

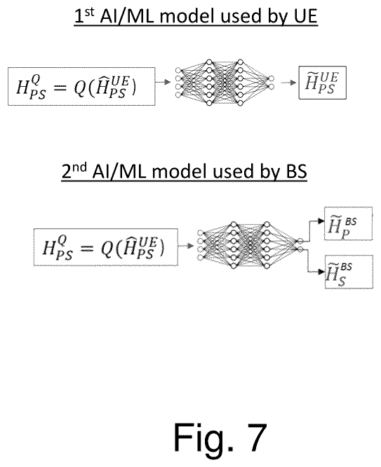

FIG. 7 shows an example of the first AI/ML learning model used by the UE and a second AI/ML used by a base station.

### Use Phase

At step 412, the BS may transmit, to the UE, a CSI-RS(t0) on the PCC. The BS may transmit, to the UE, CSI-RS (t0) on at least one of the SCCs.

At step 414, the UE may measure CSI for the

$$PCC {\hat{H}}_{P}^{UE} ( t 0 ) .$$

The UE may measure CSI for the at least one of

$$SCCs {\hat{H}}_{S}^{UE} ( t 0 ) .$$

The UE may determine a common part

$${\hat{H}}_{Ps}^{UE} ( t 0 )$$

between the CSU for the

$$PCC {\hat{H}}_{P}^{UE} ( t 0 ) .$$

and the CSI for the at least one of the SCCs

$${\hat{H}}_{S}^{UE} ( t 0 ) .$$

The UE may compress the common part

$${\hat{H}}_{Ps}^{UE} ( t 0 )$$

to obtain an uncompressed or compressed common part

$$Q ( {\hat{H}}_{Ps}^{UE} ( t 0 ) ) .$$

The UE may transmit, to the BS, the uncompressed or compressed common part

$$Q ( {\hat{H}}_{Ps}^{UE} ( t 0 ) ) .$$

At step 416, the BS may determine a prediction of CSI for the

$$PCC {\tilde{H}}_{P}^{gNB} ( t 1 )$$

and a prediction of CSI for the at least one of

$$SCCs {\tilde{H}}_{S}^{gNB} ( t 1 ) .$$

The UE may provide the uncompressed or compressed common part

$$Q ( {\hat{H}}_{Ps}^{UE} ( t 0 ) )$$

as input to the second AI/ML model. The second AI/ML model may output prediction of CSI for the

$$PCC {\tilde{H}}_{P}^{gNB} ( t 1 )$$

and the prediction of CSI for the at least one of

$$SCCs {\tilde{H}}_{S}^{gNB} ( t 1 ) .$$

At step 418, the BS may determine prediction of a common part

$${\tilde{H}}_{PS}^{gNB} ( t 1 )$$

between the prediction of CSI for the

$$PCC {\tilde{H}}_{P}^{gNB} ( t 1 )$$

and the prediction of CSI for the at least one of the

$$SCCs {\tilde{H}}_{S}^{g N B} ( t 1 ) .$$

At step 420, the BS may transmit, to the UE, CSI-RS(t1) on the PCC. The BS may transmit, to the UE, CSI-RS (t1) on the at least one of the SCCs.

At step 422, the UE may measure CSI for the

$$PCC {\hat{H}}_{P}^{U E} ( t 1 ) .$$

The UE may measure CSI for the at least one of the

$$SCCs {\hat{H}}_{S}^{U E} ( t 1 ) .$$

The UE may determine a common part

$${\hat{H}}_{P s}^{U E} ( t 1 )$$

between the CSI for the

$$PCC {\hat{H}}_{P}^{U E} ( t 1 )$$

and the CSI for the at least one of the

$$SCCs {\hat{H}}_{S}^{U E} ( t 1 ) .$$

The UE may compress the common part

$${\hat{H}}_{P s}^{U E} ( t 1 )$$

to obtain a compressed common part

$$Q ( {\hat{H}}_{P s}^{U E} ( t 1 ) ) .$$

At step 424, the UE may determine a prediction of the common

$${\tilde{H}}_{P S}^{U E} ( t 1 ) .$$

The UE may provide the uncompressed or compressed common part

$$Q ( {\hat{H}}_{P s}^{U E} ( t 0 ) )$$

as input to the first AI/ML model. The first AI/ML model may output the prediction of the common part

$${\tilde{H}}_{P S}^{U E} ( t 1 ) .$$

The UE may determine an update (e.g., difference) Δₜ₁ between the prediction of a common part

$${\tilde{H}}_{P S}^{g N B} ( t 1 )$$

and the common part

$${\hat{H}}_{P s}^{U E} ( t 1 ) .$$

At step 426, the UE may determine whether the update Δₜ₁ is greater than a threshold τ1. The threshold τ1 may define an error (e.g., mean-squared error) in an update function Up. The threshold 96 1may be pre-configured at the UE or defined in the specification (e.g., 3GPP standard) or received by the UE from the BS.

It will be understood that subsequent thresholds τ2, τ3, τ4 . . . for subsequent time instances τ2, τ3, τ4 . . . may be pre-configured at the UE or defined in specification (e.g., 3GPP standard) or received by the UE from the BS. The thresholds τ1, τ2, τ3, τ4 . . . may the same or may be different.

At step 428, if the UE determines that the update Δₜ₁ is lower than the threshold τ1, the UE may not transmit the update Δₜ₁ to the BS. The BS may determine an updated common part H̅_{PS}(t₁) based on the prediction of a common part

$${\tilde{H}}_{P S}^{g N B} ( t 1 ) .$$

The updated common part H̅_{PS}(t₁) may be equal to the prediction of a common part

$${\tilde{H}}_{P S}^{gNB} ( t 1 ) .$$

At step 430, if the UE determines that the update Δₜ₁ is greater than the threshold τ, the UE may transmit the update Δₜ₁ to the BS. The BS may determine an updated common part H̅_{PS}(t₁) based on the prediction of a common part

$${\tilde{H}}_{P S}^{gNB} ( t 1 )$$

and the update Δₜ₁. The updated common part H̅_{PS}(t₁) may equal to the difference between the prediction of a common part

$${\tilde{H}}_{P S}^{gNB} ( t 1 )$$

and the update Δₜ₁.

$${\overline{H}}_{P S} ( {t}_{1} ) = {U}_{D} ( {\tilde{H}}_{P S}^{g N B} ( {t}_{1} ) , {Δ}_{t 1} ) = {\tilde{H}}_{P S}^{g N B} ( {t}_{1} ) - {Δ}_{t 1}$$

At step 432, the UE may compress the updated common part H̅_{PS}(t₁) to obtain a compressed updated common part Q(H̅_{PS}(t₁)).

At step 434, the BS may determine a prediction of CSI for the

$$PCC {\tilde{H}}_{P}^{gNB} ( t 2 )$$

and a prediction of CSI for the at least one of the

$$SCCs {\tilde{H}}_{S}^{gNB} ( t 2 ) .$$

The UE may provide the uncompressed or compressed updated common part Q(H̅_{PS}(t₁)).as input to the second AI/ML model. The second AI/ML model may output prediction of CSI for the

$$PCC {\tilde{H}}_{P}^{gNB} ( t 2 )$$

and the prediction of CSI for the at least one of

$$SCCs {\tilde{H}}_{S}^{gNB} ( t 2 ) .$$

The process may loop back to step 420.

It will be understood steps 420, 422, 424, 426, 428, 430, 432 and 434 may be repeated with the time t1 being updated to t2 t3, t4. . . . In this way, the BS may determine predictions of CSI for the

$$PCC {\tilde{H}}_{P}^{gNB} ( t 3 ) , {\tilde{H}}_{P}^{gNB} ( t 4 ) , {\tilde{H}}_{P}^{gNB} ( t 5 )$$

and predictions of CSI for the at least one of the

$$SCCs {\tilde{H}}_{S}^{gNB} ( t 3 ) , {\tilde{H}}_{S}^{gNB} ( t 4 ) , {\tilde{H}}_{S}^{gNB} ( t 5 )$$

It will be understood that, for time t2 t3, t4 and so on, at step 424, the UE may determine a prediction of the common part

$${\tilde{H}}_{P S}^{UE} ( t 2 ) , {\tilde{H}}_{P S}^{UE} ( t 3 ) , {\tilde{H}}_{P S}^{UE} ( t 4 )$$

The UE may provide the uncompressed or compressed common part

$$Q ( {\hat{H}}_{Ps}^{UE} ( t 1 ) ) , Q ( {\hat{H}}_{P s}^{UE} ( t 2 ) ) , Q ( {\hat{H}}_{P s}^{UE} ( t 3 ) )$$

as input to the first AI/ML model. The first AI/ML model may output the prediction of the common part

$${\tilde{H}}_{P S}^{UE} ( t 2 ) , {\tilde{H}}_{P S}^{UE} ( t 3 ) , {\tilde{H}}_{P S}^{UE} ( t 4 )$$

Alternatively, the UE may provide an uncompressed or compressed prediction of a common part

$$Q ( {\tilde{H}}_{P S}^{UE} ( t 1 ) ) , Q ( {\tilde{H}}_{P S}^{UE} ( t 2 ) ) , Q ( {\tilde{H}}_{P S}^{UE} ( t 3 ) )$$

as input to the first AI/ML model. The first AI/ML model may output the prediction of the common part

$${\tilde{H}}_{P S}^{UE} ( t 2 ) , {\tilde{H}}_{P S}^{UE} ( t 3 ) , {\tilde{H}}_{P S}^{UE} ( t 4 )$$

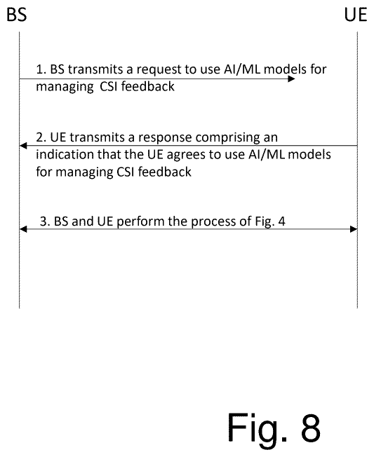

FIG. 8 shows an example of a signaling diagram of a process, performed by a UE and a BS, for managing CSI feedback.

At step 1, the BS may transmit, to the UE, a request to receive UE capability information indication whether UE supports the use of AI/ML models for managing CSI feedback.

At step 2, UE transmits a response comprising UE capability information indication that UE supports the use of AI/ML models for managing CSI feedback. The response may comprise characteristics of the first AI/ML model. The characteristics of the first AI/ML model may comprise a number of layers of a neural network and/or a number of nodes per layer of a neural network. The response may comprise characteristics of a training data set. The characteristics of the training data set comprise a length of the training data set to train the first machine learning model. The characteristics of the training data set comprise labels of a data entries of the training data set. The response may comprise the threshold a.

At step 3, the BS and the UE may perform the process of FIG. 4.

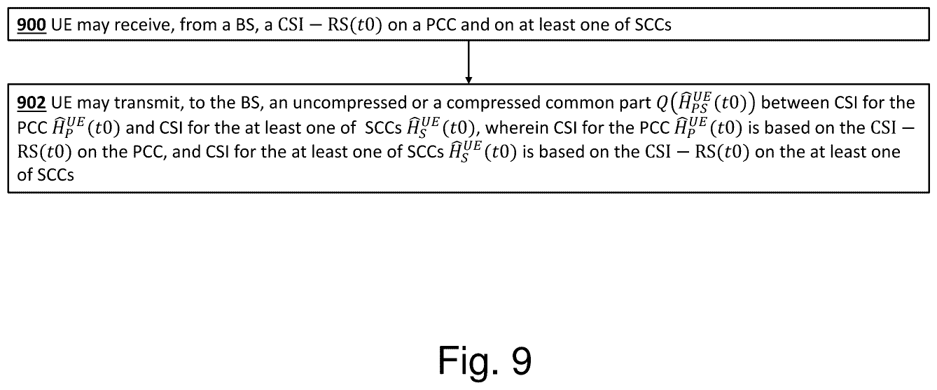

FIG. 9 shows an example of a block diagram of a method, performed by a UE, for managing CSI feedback.

At step 900, a UE may receive, from a BS, CSI-RS(t0) on a PCC and on at least one of SCCs.

At step 902, the UE may transmit, to the BS, an uncompressed or a compressed common part

$$Q ( {\hat{H}}_{P S}^{UE} ( t 0 ) )$$

between CSI for the

$$PCC {\hat{H}}_{P}^{UE} ( t 0 )$$

and CSU for the at least one of

$$SCCs {\hat{H}}_{S}^{UE} ( t 0 ) ,$$

wherein CSI for the

$$PCC {\hat{H}}_{P}^{UE} ( t 0 )$$

is based on the CSI-RS(t0) on the PCC, and the CSI for the at least one of

$$SCCs {\hat{H}}_{S}^{UE} ( t 0 )$$

is based on the CSI-RS(t0) on the at least one of SCCs.

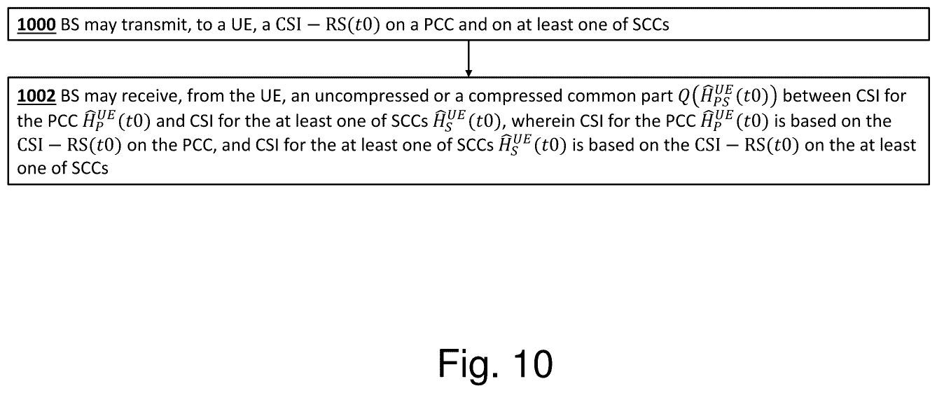

FIG. 10 shows an example of a block diagram of a method, performed by a BS, for managing CSI feedback.

At step 1000, a BS may transmit, to a UE, CSI-RS(t0) on a PCC and on at least one of SCCs.

At step 1002, the BS may receive, from the UE, an uncompressed or a compressed common part

$$Q ( {\hat{H}}_{P S}^{UE} ( t 0 ) )$$

between CSI for the

$$PCC {\hat{H}}_{P}^{UE} ( t 0 )$$

and CSI for the at least one of

$$SCCs {\hat{H}}_{S}^{UE} ( t 0 ) ,$$

wherein CSI for the

$$PCC {\hat{H}}_{P}^{UE} ( t 0 )$$

is based on the CSI-RS(t0) on the PCC, and CSI for the at least one of

$$SCCs {\hat{H}}_{S}^{UE} ( t 0 )$$

is based on the CSI-RS(t0) on the least one of SCCs.

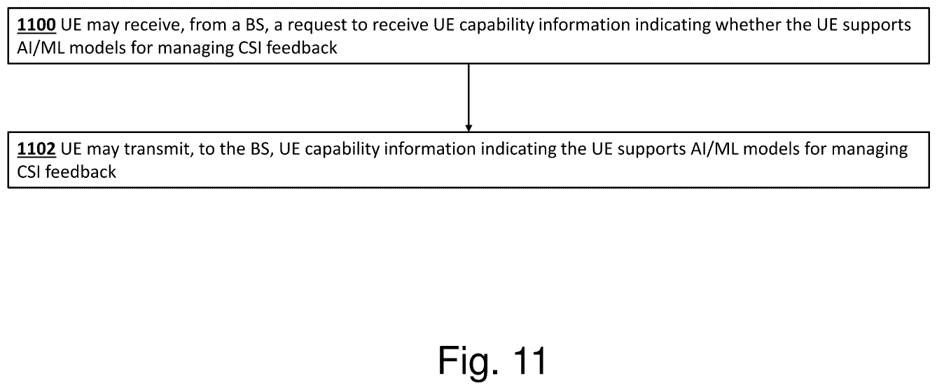

FIG. 11 shows an example of a block diagram of a method, performed by a UE, for managing CSI feedback.

At step 1100, a UE may receive, from a BS, a request to receive UE capability information indicating whether the UE supports AI/ML models for managing CSI feedback.

At step 1102, the UE may transmit, to the BS, UE capability information indicating the UE supports AI/ML models for managing CSI feedback.

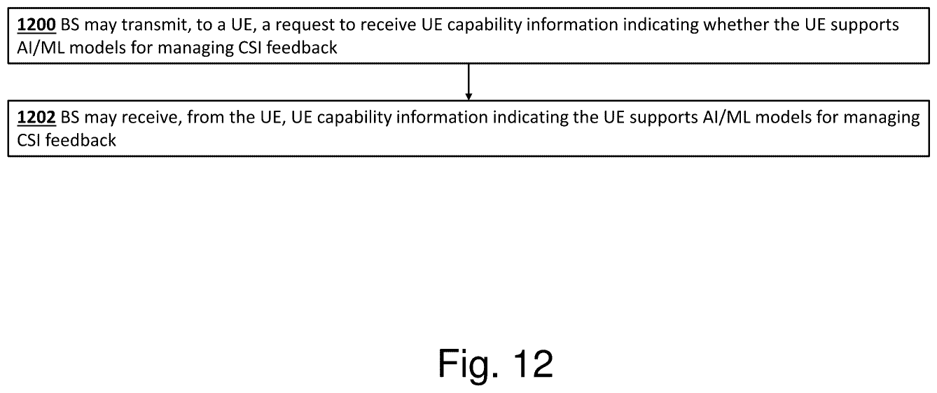

FIG. 12 shows an example of a block diagram of a method, performed by a BS, for managing CSI feedback.

At step 1200, a BS may transmit, to a UE, a request to receive UE capability information indicating whether the UE supports AI/ML models for managing CSI feedback.

At step 1202, the BS may receive, from the UE, UE capability information indicating the UE supports AI/ML models for managing CSI feedback.

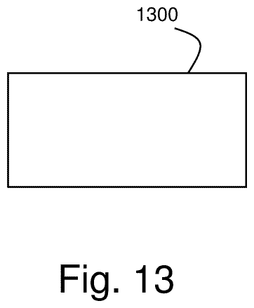

FIG. 13 shows a schematic representation of non-volatile memory media 1200 storing instructions which when executed by a processor allow the processor to perform one or more of the steps of the methods of FIG. 9 to FIG. 12.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 9 to FIG. 12, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1.-22. (canceled)

23. A user equipment comprising:
a processor; and
a memory comprising computer-executable instructions that, when executed by the processor, cause the user equipment to perform the following operations:
receive, from a base station, a channel state information reference signal (CSI-RS) on a primary component carrier (PCC) and on at least one secondary component carrier (SCC);
measure, based on the CSI-RS, first channel state information (CSI) for the PCC and second CSI for the at least one SCC;
determine, based on the first and second CSI, a common part comprising a third vector of elements, wherein each element of the third vector is determined to be present in both the first and second CSI vectors or to differ from a corresponding element by less than a threshold;
compress the third vector of elements to obtain a compressed common part;
input the compressed common part into a first machine learning model stored at the user equipment to generate a predicted common part for a subsequent time instance;
measure a current common part based on updated CSI-RS received at the subsequent time instance;
determine an update between the predicted common part and the current common part;
compare the update to a first threshold; and
in response to determining that the update exceeds the first threshold, cause the update of the predicted common part to be used as input to a machine learning model to generate a prediction of channel state information for a primary component carrier and at least one secondary component carrier.

24. The user equipment of claim 23, wherein the common part is determined using a function that compares each element of the first CSI to the second CSI using a hash table or dictionary structure.

25. The user equipment of claim 23, wherein the common part is determined by computing an intersection between normalized eigenvectors of the first CSI and the second CSI.

26. The user equipment of claim 23, wherein the common part is determined by computing a difference between a normalized eigenvector of the PCC CSI at a current time and a previous time, and between a normalized eigenvector of the SCC CSI at the current time and a previous time, and computing an intersection of the differences.

27. The user equipment of claim 23, wherein the common part is determined using a function that compares only the first three ranked eigenvector elements of the PCC CSI and SCC CSI for equality.

28. The user equipment of claim 27, wherein the update comprises a mean squared error between the predicted common part and the current common part.

29. The user equipment of claim 28, wherein the instructions further cause the user equipment to transmit the compressed common part to the base station prior to generation of the prediction.

30. A method performed by a user equipment for managing channel state information feedback, the comprising:
receiving, from a base station, a channel state information reference signal (CSI-RS) on a primary component carrier (PCC) and on at least one secondary component carrier (SCC);
measuring, based on the CSI-RS, first channel state information (CSI) for the PCC and second CSI for the at least one SCC;
determining, based on the first and second CSI, a common part comprising a third vector of elements, wherein each element of the third vector is determined to be present in both the first and second CSI vectors or to differ from a corresponding element by less than a threshold;
compressing the third vector of elements to obtain a compressed common part;
inputting the compressed common part into a first machine learning model stored at the user equipment to generate a predicted common part for a subsequent time instance;
measuring a current common part based on updated CSI-RS received at the subsequent time instance;
determining an update between the predicted common part and the current common part;
comparing the update to a first threshold; and
in response to determining that the update exceeds the first threshold, causing the update of the predicted common part to be used as input to a machine learning model to generate a prediction of channel state information for a primary component carrier and at least one secondary component carrier.

31. The method of claim 30, wherein the common part is determined using a function that compares each element of the first CSI to the second CSI using a hash table or dictionary structure.

32. The method of claim 30, wherein the common part is determined by computing an intersection between normalized eigenvectors of the first CSI and the second CSI.

33. The method of claim 30, wherein the common part is determined using a function that compares only the first three ranked eigenvector elements of the PCC CSI and SCC CSI for equality.

34. The method of claim 30, wherein the common part is determined by computing a difference between a normalized eigenvector of the PCC CSI at a current time and a previous time, and between a normalized eigenvector of the SCC CSI at the current time and a previous time, and computing an intersection of the differences.

35. The method of claim 34, wherein the update comprises a mean squared error between the predicted common part and the current common part.

36. The method of claim 35, wherein the instructions further cause the user equipment to transmit the compressed common part to the base station prior to generation of the prediction.

37. A system comprising:
a user equipment comprising:
a processor; and
a memory comprising computer-executable instructions that, when executed by the processor, cause the user equipment to perform the following operations:
receive, from a base station, a channel state information reference signal (CSI-RS) on a primary component carrier (PCC) and on at least one secondary component carrier (SCC);
measure, based on the CSI-RS, first channel state information (CSI) for the PCC and second CSI for the at least one SCC;
determine, based on the first and second CSI, a common part comprising a third vector of elements, wherein each element of the third vector is determined to be present in both the first and second CSI vectors or to differ from a corresponding element by less than a threshold;
compress the third vector of elements to obtain a compressed common part;
input the compressed common part into a first machine learning model stored at the user equipment to generate a predicted common part for a subsequent time instance;
measure a current common part based on updated CSI-RS received at the subsequent time instance;
determine an update between the predicted common part and the current common part;
compare the update to a first threshold; and
in response to determining that the update exceeds the first threshold, cause the update of the predicted common part to be used as input to a machine learning model to generate a prediction of channel state information for a primary component carrier and at least one secondary component carrier.

38. The user equipment of claim 37, wherein the common part is determined using a function that compares each element of the first CSI to the second CSI using a hash table or dictionary structure.

39. The user equipment of claim 37, wherein the common part is determined by computing an intersection between normalized eigenvectors of the first CSI and the second CSI.

40. The user equipment of claim 37, wherein the common part is determined by computing a difference between a normalized eigenvector of the PCC CSI at a current time and a previous time, and between a normalized eigenvector of the SCC CSI at the current time and a previous time, and computing an intersection of the differences.

41. The user equipment of claim 37, wherein the common part is determined using a function that compares only the first three ranked eigenvector elements of the PCC CSI and SCC CSI for equality.
